(19) United States
(12) Patent Application Publication
(10) Pub. No.: US 2026/0204240 A1
(43) Pub. Date: Jul. 16, 2026

(54) BAGPIPE REED ANTIFOULING APPARATUS

(71) Applicant: Warren W. Smith, Durham, NH (US)

(72) Inventor: Warren W. Smith, Durham, NH (US)

(21) Appl. No.: 19/445,217

(22) Filed: Jan. 9, 2026

Related U.S. Application Data
(60) Provisional application No. 63/743,921, filed on Jan. 10, 2025.

(51) Int. Cl. G10D 9/035; G10D 7/063

(52) U.S. Cl. CPC G10D 9/035; G10D 7/063

(57) ABSTRACT

A bagpipe reed antifouling blowpipe comprising: a mouthpiece, a bag connector in fluid communication with a bag of a bagpipe, an airpath extending between the mouthpiece and the bag connector, one or more moisture condensing sections, forming a portion of the airpath, configured to remove moisture from air passing therethrough by causing condensation, one or more bends in the airpath, configured to direct condensed moisture towards a liquid collecting section, a liquid collecting section positioned at a lower portion of the airpath to collect condensed moisture, and a liquid removing section configured to enable moisture removal from the liquid collecting section while maintaining substantial air-tightness during operation of the bagpipe.

### RELATED APPLICATIONS

This application claims the benefit of U.S. Provisional Applications 63/743,921, filed Jan. 10, 2025, incorporated herein by reference in its entirety for all purposes.

### FIELD

The present disclosure relates to a bagpipe reed antifouling apparatus, and more specifically, to a bagpipe reed antifouling apparatus that prevents fouling of a bagpipe reed through removal of moisture from the air that is blown into the bagpipe, prior to the air entering the bag of the bagpipe.

### BACKGROUND

Many types of bagpipes are played through a musician, known as a “piper,” forcing air from the mouth of the piper into a tube, termed a “blowpipe” that is in fluid communication with an air bladder, termed a “bag,” to thereby deliver the blown air under pressure into the interior of the bag. While the bagpipe is being played, the pressurized air within the bag is caused to pass through one or more reeds, causing the reed or reeds to vibrate, producing a tone. The bag serves as a reservoir for air, enabling the flow of pressurized air through the reeds to be sustained even when the piper stops blowing in order to inhale.

A common problem experienced with conventional bagpipes is that of fouling of the reeds in the bagpipe due to accumulation of moisture on the reed. When a bagpipe is being played, the air blown by the piper into the bag tends to be moist and near to the body temperature of the piper, and the blown air may also include spittle. When this moist air comes into contact with parts of the bagpipe that are cooler than body temperature, condensation occurs, causing surfaces to become wet. This problem is particularly severe when playing outdoors in cold weather.

In the case of the great highland bagpipe, in particular, the bagpipe is configured with three pipes, known as “drones,” extending substantially upwardly from the bag. Each drone is equipped with a respective reed equipped at the bottom end thereof. After the warm moist air is forced through the reed to cause the vibration, the warm moist air then travels up the drone. As the drone tends to be cooler than the moist air, especially when the bagpipe is being played in cold weather, moisture condenses into a liquid on the inner surface of the drone. The condensed liquid then runs down the inner surface of the drone, under the force of gravity, to arrive at the reed at the bottom. As the aperture of the reed is small, and air passing in the upward direction prevents drainage of the liquid therethrough, the liquid that is the result of condensation tends to accumulate on the reed. The accumulated moisture may interfere with the passage of air through the reed, or may otherwise change the vibrational properties of the reed, negatively affecting performance. This often requires the piper to stop and dry the pipes before the pipes can again be played satisfactorily.

As this problem is well known to those skilled in the art of piping, various approaches to bagpipe reed antifouling have been proposed. Conventional approaches taken to prevent fouling of bagpipe reeds fall into three categories: 1) elimination of moisture from the bagpipe by replacing mouth blowing with the use of a bellows; 2) use of hydrophilic materials in the reed body to prevent moisture from accumulating on the vibrating element of the reed, and 3) use of absorbent material placed within the bag or blowpipe, to capture and sequester spittle and other moisture, preventing it from reaching the reed.

These three approaches, however, have their respective drawbacks. For example, the use of bellows, as often seen in varieties of bagpipes known as “small pipes” and “border pipes,” significantly increases the complexity of the bagpipe and its operation, making the use of bellows-equipped pipes intimidating to many pipers. Moreover, bellows are fundamentally incompatible with the better-known great highland bagpipe, and if used with the highland bagpipe would represent a significant departure from the traditional mode of operation thereof, preventing participation in, for example, group playing in a bagpipe band, where all pipers are expected to play their bagpipes using the traditional mouth-blown technique.

The use of hydrophilic materials in the reed body of a drone reed has become quite common, such as in the increased absorption “Ezeedrone” bagpipe drone reeds that are easily available online or through bagpipe supply distributors. While such increased-absorption drone reeds provide some slight degree of relief for the problem of fouling of drone reeds, the solution is incomplete, and pipers still suffer from fouled reeds, especially when playing in a cold environment.

Because the problem of fouled reeds is still ubiquitous in mouth-blown bagpipes despite the use of hydrophilic materials in the reed bodies, most pipers who play the great highland pipes use some form of moisture remediation system to absorb liquids within the bag. The form taken in extant systems for moisture remediation in bagpipe reed antifouling systems involves the use of a flexible tube, in fluid communication with the bag end of the blowpipe, to direct the blown air to pass through an absorbing body, disposed within the bag, before the air is released into the bag, enabling the air to flow, under pressure, through the reed. Although such systems are able to capture and sequester, in the absorbent material that is placed within the bag, spittle and whatever moisture happens to condense within the blowpipe and the flexible tube, the absorbent material quickly saturates to ceases to collect further moisture, and the absorbent material is incapable of capturing the water vapor that is inherent to the warm moist air that is blown into the bag. Moreover, because the flexible tube and absorbent material is disposed within the bag, and the environment within the bag is relatively warm when compared to, for example, the external environment, there is little removal of moisture from the air prior to the air reaching the drones, through condensation in the flexible tube of moisture remediation system prior to the warm moist air passing the absorbent material and being released into the bag, leaving moisture in the air that will readily condense on the inner walls of the colder drones, leading to fouling of the drone reeds. Thus such systems are of limited effect, and pipers still suffer from fouled reeds, especially when playing in a cold environment.

Accordingly, an improved bagpipe reed antifouling apparatus is provided that more effectively prevents fouling of reeds caused by condensation of moisture in the drones, captures spittle effectively without saturating absorbent material within the bag, and operates without the use of bellows.

### SUMMARY

The present disclosure relates to a bagpipe reed antifouling apparatus able to more effectively prevent the fouling of reeds that results from condensation of moisture in the drones, that captures spittle effectively without saturating absorbent material within the bag, and that does not require bellows.

One embodiment provides a bagpipe reed antifouling apparatus for use in reducing fouling of a reed in a bagpipe that comprises a bag, comprising: an airpath configured to convey air, one or more moisture condensing sections, forming a portion of the airpath, configured to remove moisture from air passing therethrough by causing condensation, one or more bends in the airpath, configured to direct condensed moisture towards a liquid collecting section, a liquid collecting section positioned at a lower portion of the airpath to collect condensed moisture, and a liquid removing section configured to enable moisture removal from the liquid collecting section while maintaining substantial air-tightness during operation of the bagpipe, wherein the one or more moisture condensing sections is disposed external to the bag of the bagpipe.

Another embodiment provides such a bagpipe reed antifouling apparatus, wherein the moisture condensing section comprises a tubular structure made of a highly thermally conductive material having a thermal conductivity in excess of 10 W/m K.

A further embodiment provides such a bagpipe reed antifouling apparatus, wherein the inner diameter of each of the one or more moisture condensing sections is between 10 mm and 14.5 mm.

Yet another embodiment provides such a bagpipe reed antifouling apparatus, wherein the moisture condensing section comprises copper tubing.

A yet further embodiment provides such a bagpipe reed antifouling apparatus, wherein the liquid removing section comprises a drain with a removable plug or a valve configured to switch between an air-tight state and an open state to allow drainage.

Still another embodiment provides such a bagpipe reed antifouling apparatus, wherein the liquid removing section comprises a fitting configured to enable removal of a portion of the airpath.

A still further embodiment provides such a bagpipe reed antifouling apparatus, further comprising a tubular vented covering for covering at least a portion of the one or more moisture condensing sections, with openings configured to enable outside air to reach the portion of the moisture condensing section and/or to allow the portion of the moisture condensing section to be seen through the openings.

Even another embodiment provides such a bagpipe reed antifouling apparatus, wherein the liquid removing section comprises a joint configured such that, under operating pressure conditions, a volumetric flow rate of liquid through the joint exceeds a volumetric flow rate of air through the joint by at least an order of magnitude.

One embodiment further provides a bagpipe reed antifouling blowpipe comprising: a mouthpiece, a bag connector in fluid communication with a bag of a bagpipe, an airpath extending between the mouthpiece and the bag connector, one or more moisture condensing sections, forming a portion of the airpath, configured to remove moisture from air passing therethrough by causing condensation, one or more bends in the airpath, configured to direct condensed moisture towards a liquid collecting section, a liquid collecting section positioned at a lower portion of the airpath to collect condensed moisture, and a liquid removing section configured to enable moisture removal from the liquid collecting section while maintaining substantial air-tightness during operation of the bagpipe.

Another embodiment provides such a bagpipe reed antifouling blowpipe, wherein the bends are configured such that the exit end of the airpath is substantially coaxial with the entrance end of the airpath.

A further embodiment provides such a bagpipe reed antifouling blowpipe, wherein the moisture condensing section comprises a tubular structure made of a highly thermally conductive material having a thermal conductivity in excess of 10 W/m K.

Yet another embodiment provides such a bagpipe reed antifouling blowpipe, wherein the inner diameter of the moisture condensing section is between 10 mm and 14.5 mm.

A yet further embodiment provides such a bagpipe reed antifouling blowpipe, wherein the moisture condensing section comprises copper tubing.

Still another embodiment provides such a bagpipe reed antifouling blowpipe, wherein the liquid removing section comprises a drain with a removable plug or a valve configured to switch between an air-tight state and an open state to allow drainage.

A still further embodiment provides such a bagpipe reed antifouling blowpipe, wherein the liquid removing section comprises a fitting configured to enable removal of a portion of the airpath.

Even another embodiment provides such a bagpipe reed antifouling blowpipe, further comprising a tubular vented covering for covering at least a portion of the one or more moisture condensing sections, with openings configured to enable outside air to reach the portion of the moisture condensing section and/or to allow the portion of the moisture condensing section to be seen through the openings.

An even further embodiment provides such a bagpipe reed antifouling blowpipe, wherein the liquid removing section comprises a joint configured such that, under operating pressure conditions, a volumetric flow rate of liquid through the joint exceeds a volumetric flow rate of air through the joint by at least an order of magnitude.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes, and not to limit the scope of the inventive subject matter.

### BRIEF DESCRIPTION OF THE DRAWINGS

FIG. 1 is a side view of a bagpipe reed antifouling apparatus according to an embodiment.

FIG. 2 is a side view of a bagpipe reed antifouling blowpipe according to another embodiment.

FIG. 3 is a perspective diagram of a bagpipe reed antifouling blowpipe according to yet another embodiment.

FIG. 4 is a perspective diagram of a bagpipe reed antifouling blowpipe, showing a valve for draining liquid, according to even yet another embodiment.

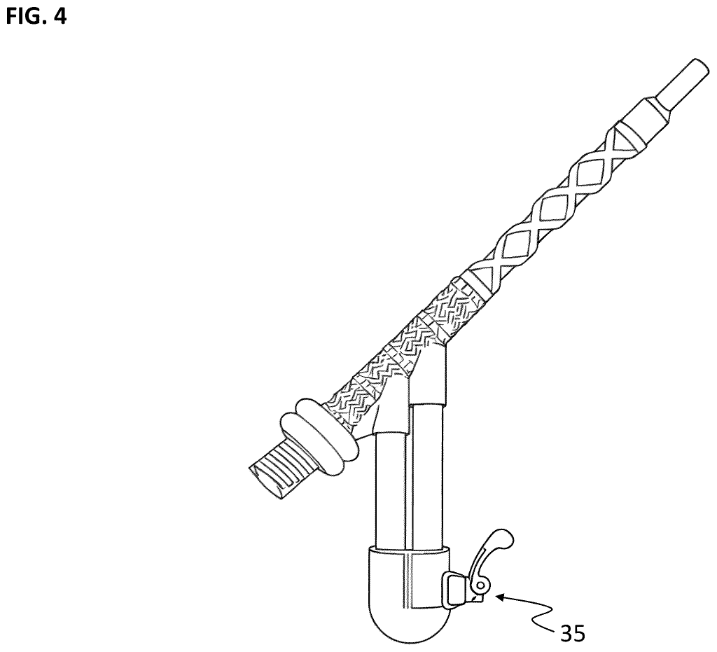

### DETAILED DESCRIPTION

The present disclosure will include explanations of embodiments based on the appended drawings; note however that the scope of the present disclosure is not limited to the illustrated embodiments described herein.

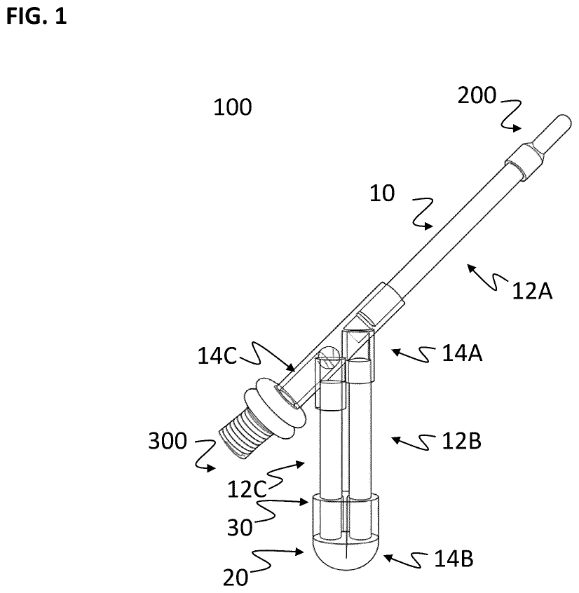

FIG. 1 is a side view of a bagpipe reed antifouling apparatus 100 according to an embodiment, wherein, for convenience, some parts are illustrated as if formed from a transparent material to enable viewing of the internal structure. As depicted in FIG. 1, in embodiments the bagpipe reed antifouling apparatus 100 comprises an air path 10 for conveying air, forced into the air path 10 by the piper blowing through a mouthpiece 200 that is in fluid communication with the airpath 10, to a bag connector 300 that is in fluid communication with a bag (not illustrated) of the bagpipe. In embodiments, the airpath 10 comprises one or more moisture condensing sections 12 (indicated as 12A, 12B, and 12C in FIG. 1) and one or more bends 14 (indicated as 14A, 14B, and 14C in FIG. 1). In embodiments, the bagpipe reed antifouling apparatus 100 further comprises one or more liquid collecting sections 20 and one or more liquid removing section 30.

As depicted in FIG. 1, in embodiments that airpath 10 may comprise three condensing sections 12A, 12B, and 12C and three bends 14A, 14B, and 14C, although there is no limitation thereto. In embodiments, the condensing section 12 is configured to transfer thermal energy from the warm, moisture-laden air blown into the airpath 10 to the surrounding environment, thereby cooling the air sufficiently to promote condensation of water vapor contained therein. Thus in embodiments the condensing section 12 is formed from a highly thermally conductive material, defined here as a material that is commonly selected by those skilled in the art of design of thermal transfer components as a material for fabricating parts that function to transfer heat energy. In embodiments the condensing section 12 is formed from a material having a thermal conductivity in excess of 10 W/m K, such materials being of high thermal conductivity when compared to wood, a material commonly used in making blowpipes for bagpipes, where wood typically has thermal conductivity of less than 0.3 W/m K. Well-suited high thermal conductivity materials include, for example, copper, aluminum, silver, gold, brass, bronze, graphite, steel (carbon), tungsten, beryllium, zinc, nickel, iron, molybdenum, platinum, palladium, lead, tantalum, and silicon carbide, without limitation thereto.

In embodiments, the condensing section 12 may be formed from copper tubing, which is known to have a thermal conductivity of approximately 330 W/m K. In embodiments the condensing section 12 is generally cylindrically tubular in shape. To facilitate cooling in the condensing section 12, the wall thickness of a tubular condensing section 12 may be less than 1.5 mm, which is thin compared to the wall thickness of several millimeters in a conventional great highland bagpipe blowpipe that is fabricated from wood or plastic. In embodiments the inner diameter of a tubular condensing section 12 may be between 10 and 14.5 mm, where if less than 10 mm the airpath 10 could develop enough back pressure to interfere with the piper blowing air through the airpath 10, and if greater than 14.5 mm the size of the condensing section 12 could cause the bagpipe reed antifouling apparatus 100 to be bulky or unwieldy. Note that wall thicknesses and inner diameters listed above as embodiments of the condensing section 12 include the standards for commercially available ⅜-inch and ½-inch copper tubing. While in the embodiment of the condensing section 12 depicted in FIG. 1 the condensing section 12 is illustrated as a straight portion of the airpath 10, in other embodiments the condensing section 12 may instead be bent or curved. In embodiments the condensing section 12 may be formed in any shape, including straight, coiled, helical, serpentine, spiral, U-shaped, looped, finned, dimpled, perforated, tapered, swaged, twisted, or the like, without limitation. The cross-sectional shape and size of the condensing section may be uniform through the condensing section 12 (or across multiple condensing sections 12), or may be varied. The cross-sectional shape of the condensing section 12 may be circular, polygonal, oval or elliptical, irregular, or the like, without limitation.

As illustrate in FIG. 1, the airpath 10 between the mouthpiece 200 and the bag connector 300 of embodiments comprises one or more bends 14 (14A, 14B, and 14C in FIG. 1). In embodiments the bends 14 in the airpath 10 function to allow air that is introduced into one end of the airpath 10 at one location and angle to be released at the opposite end of the airpath 10 at a desired location and angle. In embodiments the airpath 10 may comprise bends designed so that the airpath 10 near the exit end thereof is substantially parallel and/or coaxial with the airpath 10 near the entrance end thereof. In embodiments a bend 14 of the airpath 10 may be defined by a shape formed from a material that is separate from that of the condensing sections 12, as illustrated in FIG. 1. While in the embodiment illustrated in FIG. 1 each bend 14 is fabricated from a material, such as a plastic material, for example, other than that of the condensing sections 12, one or more of the bends 14 may be formed in a condensing section 12 itself through bending of the material from which the condensing section 12 is formed. In embodiments, a U-shaped bend 14 may be formed in a condensing section 12 that is formed from, for example, copper tubing.

In embodiments, such as depicted in FIG. 1, a the liquid collecting section 20 is formed in a bend 14 in the airpath 10, as a portion of the bend 14 (14B) that disposed below than other portions of the airpath 10 so as to be a local minimum in height while the bagpipe is in operation, allowing moisture that condenses in the condensing sections 12 (12A, 12B, and 12C in FIG. 1) to accumulate, under the force of gravity, in the liquid collecting section 20. Note that, in embodiments, the boundaries of the liquid collecting section 20 in the bend 14B may vary during use, depending on the angle with which the bagpipe is held and the amount of liquid that has pooled. In embodiments the liquid collecting section 20 is located lower than the bag connector 300 that is connected to the bag (not numbered) to facilitate collecting of the condensed liquid in liquid collecting section 20 without the condensed liquid running through the bag connector 300 into the bag. In embodiments the liquid collecting section 20 may further include a liquid container, not shown, that is connected by an opening to a portion of the bend 14 that is near to the local height minimum of the bend 14, referenced above. In embodiments the liquid container may be, for example, a bottle, a tube that extends in a generally downward direction from a Y-joint or other three-way joint or tube splitter that is connected near the local height minimum, a portion of airpath 10 that is enlarged so as to have a larger cross-sectional area, or the like, without limitation. Thus while in embodiments the liquid collecting section 20 constitutes a section of the airpath 10, in other embodiments the liquid collecting section 20 is not part of the airpath 10 but is connected thereto, while in other embodiments the liquid collecting section 20 comprises a section of the airpath 10 and also a liquid container that is not part of the airpath 10. In embodiments an absorbent material, not shown, may be placed within the liquid collecting section 20 to capture and immobilize collected liquid. In embodiments, the overall configuration of the airpath 10 is such that the liquid collecting section 20 is positioned to receive liquid that condenses in the one or more moisture condensing sections 12 and that runs down inner walls of the moisture condensing sections 12 and bends 14, configured so that the inner walls slope downward towards the liquid collecting section 20 when the bagpipe is in operation.

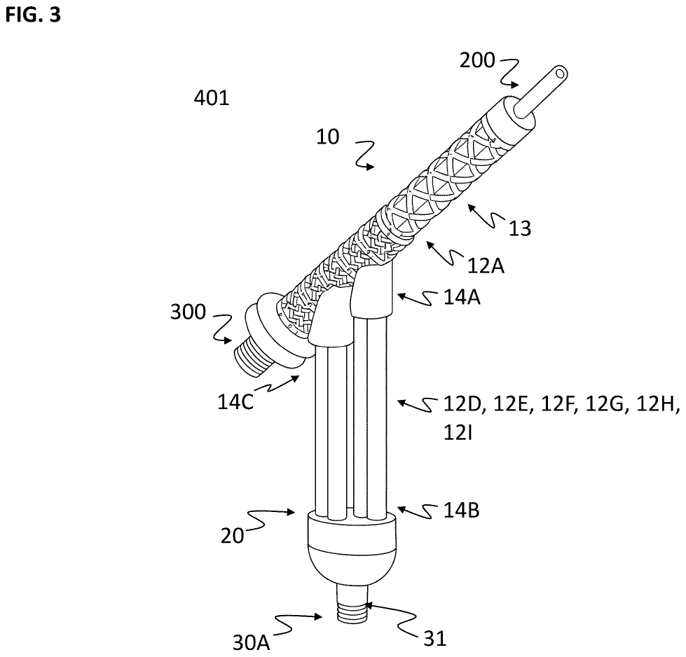

In embodiments the liquid removing section 30 are configured to enable liquid to be removed from the liquid collecting section 20 during a pause in the performance, while maintaining substantial air-tightness otherwise. In embodiments the substantial air-tightness is not perfectly air-tight, but rather allows a limited amount of leakage. In embodiments such as illustrated in FIG. 1, the liquid removing section 30 may comprise one or more slide joints allowing removal of at least a portion of the liquid collecting section from the airpath 10 to allow the liquid to be dumped and/or drained from the liquid collecting section 20. In embodiments the liquid removing section 30 may be configured from a drain with a removable plug, as depicted in FIG. 3. In embodiments the liquid removing section 30 may be configured from a valve 35 that can open and close to enable switching between a substantially air-tight state and a state wherein liquid can drain from the liquid collecting section 20, where the valve 35 is located at a lower portion of the liquid collecting section 20.

In embodiments, as illustrated in FIG. 3, the liquid removing section 30A may comprise an imperfectly air-tight joint 31, configured to leak enough to allow pressurized seepage of the collected liquid out from the liquid removing section 30A while maintaining substantial air-tightness to a degree that does not interfere with operation of the bagpipe. In embodiments, the imperfectly air-tight joint 31 is configured to define a controlled leakage path at the bottom of the liquid collecting section 20, as depicted in FIG. 3, wherein, under operating pressure conditions encountered during normal playing, a volumetric flow rate of liquid passing through the joint exceeds a volumetric flow rate of air passing through the joint by at least an order of magnitude, such that accumulated liquid is expelled while airflow loss remains negligible for bagpipe operation.

The bagpipe reed antifouling apparatus 100 in the embodiments set forth above operates as follows. As described above, in embodiments warm moist air is forced by the piper through the mouth piece 200 through the airpath 10 of the bagpipe reed antifouling apparatus 100 to the bag connector 300 and thence into the bag (not numbered). Assuming that the surrounding environment is cooler than the breath of the piper, as the warm moist air passes through the airpath 10, heat is transferred to the outside through thermal conduction through the thin walls of the moisture condensing section(s) 12, causing moisture to condense on the inside walls thereof. As the moisture condenses into a liquid, this liquid runs down the inside walls of the moisture condensing section(s) 12 and/or the bend(s) 14, to reach a point of minimal gravitational potential in the liquid collecting section 20, where it accumulates while the bagpipe is in operation. When deemed a suitable time by the piper, during a pause in the performance, the piper operates the liquid removing section to remove the accumulated liquid through, for example, removing and dumping the bend 14 portion of the airpath 10 that includes the liquid collecting section 20, opening a valve 35 to drain liquid that has accumulated in the liquid collecting section 20, or removing the plug 30A that is depicted in FIG. 3. Conversely, the collected liquid may seep, under pressure, through the imperfectly air-tight joint 31 to drip into the outside environment without the piper having to interrupt the performance.

This process removes moisture from the air being blown into the bagpipe before the air is released into bag and prior to the air passing through the reeds and moving upward through the drones. This air, having been subjected to a moisture removal process, will have less moisture and thus less of a tendency to produce condensation on the inner walls of the drones, and thus reduces the propensity for fouling of the bagpipe reeds. The bagpipe reed antifouling apparatus 100, configured as in the embodiments set forth above, is particularly effective in removing moisture when the ambient temperature is low, making it particularly effective in the precise environmental conditions wherein, conventionally, reed fouling has been particularly problematic.

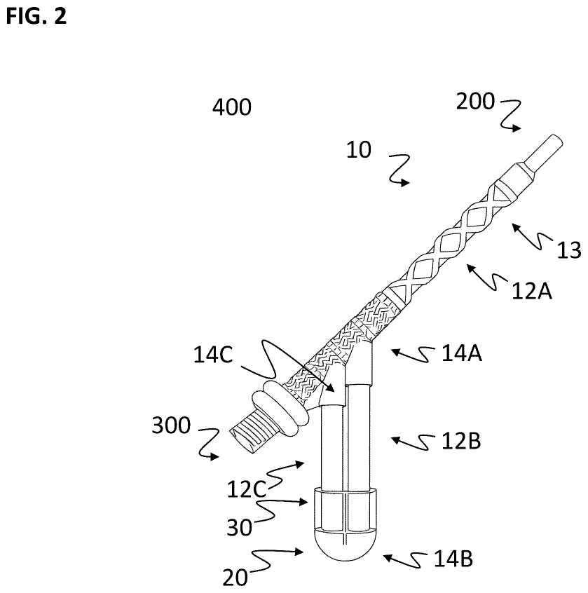

In embodiments bagpipe reed antifouling apparatus 100 may be built into a blowpipe. That is, the bagpipe reed antifouling apparatus 100 may be combined with a mouthpiece 200 and a bag connector 300 to form a bagpipe reed antifouling blowpipe 400. In embodiments, as depicted in FIG. 2, a bagpipe reed antifouling blowpipe 400 may comprise a mouthpiece 200, a bag connector 300, and a mouthpiece a tubular vented covering 13.

The tubular vented covering 13 may be configured to cover at least a portion of a moisture condensing section 12, with openings configured to enable outside air to reach the portion of the moisture condensing section 12 and/or to allow the portion of the moisture condensing section 12 to be seen through the openings. Such a tubular vented covering 13 can enhance the aesthetic appeal of the blowpipe 400, and can act to either camouflage the moisture condensing section 12 to enable a blowpipe equipped with the bagpipe reed antifouling blowpipe 400 to appear more similarly to a conventional blowpipe, or to provide a pleasing contrast between a copper-tube moisture condensing section 12 and the vented covering 13, making the bagpipe reed antifouling blowpipe 400 more visually striking and noticeable. The vented covering 13 may be configured to protect the moisture condensing section 12 from soiling and discoloration, and may be made from, for example, a plastic that is resistant to soiling. In embodiments, the moisture condensing section 12 may be configured to have a color similar to that of other portions of the bagpipe reed antifouling blowpipe 400.

As depicted in FIG. 3, in embodiments the moisture condensing section 12 in a blowpipe 401 may comprise a plurality of moisture condensing sections 12D, 12E, 12F, 12G, 12H, and 12I disposed in parallel, thereby increasing the surface are for thermal dissipation, thereby facilitating increased condensation. In FIG. 3, the liquid removing section 30A are illustrated as structured from a removable plug that is fitted into a sleeve at the bottom of the liquid collecting portion 20, with an imperfectly air-tight joint 31 between the removable plug 30A and the liquid collecting portion 20.

While the embodiments above envision that the airpath 10 connects the mouthpiece 200 and bag connector 300, the present disclosure is not limited thereto, and the same effect can be achieved in other configurations wherein the moisture condensing section(s) 12 is provided outside of the bag. For example, in embodiments a conventional blowpipe (not incorporating a moisture condensing section 12) may be used, with the airpath 10 in fluid connection with the bag side of the blowpipe within the bag, not illustrated,, with the moisture condensing section 12 protruding through a port in the bag to the outside of the bag, with the liquid collecting section 20 at a bend 14 at a lower portion of the airpath 10 on the outside of the bag, enabling the same effect as described above while still enabling the use of a standard blowpipe.

While the embodiments above envision the airpath 10 as being bent so as to form a liquid collecting portion 20 outside of the bag, in embodiments the airpath 10 from the mouthpiece 200 to the bag connector 300 may be straight, comprising one or more moisture condensing sections 12, with a liquid collecting portion 20 or an absorbent medium disposed within the bag or otherwise downstream, in the direction of airflow, of the bag connector 300. In such an embodiment the bend 14 may be located within the bag.

Note that it is envisioned that the bagpipe reed antifouling apparatus or bagpipe reed antifouling blowpipe of the embodiments set forth above may be used in conjunction with other antifouling system, as described above, that are known to those skilled in the art, such as with the in-bag moisture absorbing systems and/or moisture absorbing reeds referenced above. In embodiments a chamber or void, configured to receive a moisture absorbing or adsorbing material such as, for example, a silica gel packet, may be provided in, or contiguous with, the airpath 10.

The foregoing description of the embodiments of the disclosure has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the disclosure to the precise form disclosed. Many modifications and variations are possible in light of this disclosure.

Although the present application is shown in a limited number of forms, the scope of the disclosure is not limited to just these forms, but is amenable to various changes and modifications. The present application does not explicitly recite all possible combinations of features that fall within the scope of the disclosure. The features disclosed herein for the various embodiments can generally be interchanged and combined into any combinations that are not self-contradictory without departing from the scope of the disclosure. In particular, the limitations presented in dependent claims below can be combined with their corresponding independent claims in any number and in any order without departing from the scope of this disclosure, unless the dependent claims are logically incompatible with each other.

In the foregoing description, certain terms have been used for brevity, clearness, and understanding. No unnecessary limitations are to be implied therefrom beyond the requirement of the prior art because such terms are used for descriptive purposes and are intended to be broadly construed.

What is claimed is:

1. A bagpipe reed antifouling apparatus for use in reducing fouling of a reed in a bagpipe that comprises a bag, comprising:
an airpath configured to convey air,
one or more moisture condensing sections, forming a portion of the airpath, configured to remove moisture from air passing therethrough by causing condensation,
one or more bends in the airpath, configured to direct condensed moisture towards a liquid collecting section,
a liquid collecting section positioned at a lower portion of the airpath to collect condensed moisture, and
a liquid removing section configured to enable moisture removal from the liquid collecting section while maintaining substantial air-tightness during operation of the bagpipe, wherein:
the one or more moisture condensing sections is disposed external to the bag of the bagpipe.

2. The apparatus of claim 1, wherein:
the moisture condensing section comprises a tubular structure made of a highly thermally conductive material having a thermal conductivity in excess of 10 W/m K.

3. The apparatus of claim 1, wherein:
the inner diameter of each of the one or more moisture condensing sections is between 10 mm and 14.5 mm.

4. The apparatus of claim 1, wherein:
the moisture condensing section comprises copper tubing.

5. The apparatus of claim 1, wherein:
the liquid removing section comprises a drain with a removable plug or a valve configured to switch between an air-tight state and an open state to allow drainage.

6. The apparatus of claim 1, wherein:
the liquid removing section comprises a fitting configured to enable removal of a portion of the airpath.

7. The apparatus of claim 1, further comprising:
a tubular vented covering for covering at least a portion of the one or more moisture condensing sections, with openings configured to enable outside air to reach the portion of the moisture condensing section and/or to allow the portion of the moisture condensing section to be seen through the openings.

8. The apparatus of claim 1, wherein the liquid removing section comprises a joint configured such that, under operating pressure conditions, a volumetric flow rate of liquid through the joint exceeds a volumetric flow rate of air through the joint by at least an order of magnitude.

9. A bagpipe reed antifouling blowpipe comprising:
a mouthpiece,
a bag connector in fluid communication with a bag of a bagpipe,
an airpath extending between the mouthpiece and the bag connector,
one or more moisture condensing sections, forming a portion of the airpath, configured to remove moisture from air passing therethrough by causing condensation,
one or more bends in the airpath, configured to direct condensed moisture towards a liquid collecting section,
a liquid collecting section positioned at a lower portion of the airpath to collect condensed moisture, and
a liquid removing section configured to enable moisture removal from the liquid collecting section while maintaining substantial air-tightness during operation of the bagpipe.

10. The blowpipe of claim 9, wherein:
the bends are configured such that the exit end of the airpath is substantially coaxial with the entrance end of the airpath.

11. The blowpipe of claim 9, wherein:
the moisture condensing section comprises a tubular structure made of a highly thermally conductive material having a thermal conductivity in excess of 10 W/m K.

12. The blowpipe of claim 9, wherein:
the inner diameter of the moisture condensing section is between 10 mm and 14.5 mm.

13. The blowpipe of claim 9, wherein:
the moisture condensing section comprises copper tubing.

14. The blowpipe of claim 9, wherein:
the liquid removing section comprises a drain with a removable plug or a valve configured to switch between an air-tight state and an open state to allow drainage.

15. The blowpipe of claim 9, wherein:
the liquid removing section comprises a fitting configured to enable removal of a portion of the airpath.

16. The blowpipe of claim 9, further comprising:
a tubular vented covering for covering at least a portion of the one or more moisture condensing sections, with openings configured to enable outside air to reach the portion of the moisture condensing section and/or to allow the portion of the moisture condensing section to be seen through the openings.

17. The blowpipe of claim 9, wherein the liquid removing section comprises a joint configured such that, under operating pressure conditions, a volumetric flow rate of liquid through the joint exceeds a volumetric flow rate of air through the joint by at least an order of magnitude.
